(19) United States
(12) Patent Application Publication
(10) Pub. No.: US 2024/0100881 A1
(43) Pub. Date: Mar. 28, 2024

(54) AIRLESS TIRE

(71) Applicant: Sumitomo Rubber Industries, Ltd., Hyogo (JP)

(72) Inventor: Ai TAKEDA, Kobe-shi (JP)

(73) Assignee: Sumitomo Rubber Industries, Ltd., Hyogo (JP)

(21) Appl. No.: 18/472,737

(22) Filed: Sep. 22, 2023

(30) Foreign Application Priority Data
Sep. 28, 2022 (JP) 2022-155363

(51) Int. Cl. B60C 7/14; B60C 1/00; B60C 19/08

(52) U.S. Cl. CPC B60C 7/146; B60C 1/00; B60C 19/08

(57) ABSTRACT

It is possible to maintain high-speed durability while having a function of eliminating static electricity of a vehicle. An airless tire 1 includes a tread portion 2, an inner circumferential portion 3 which comes into contact with a wheel 5 having conductivity, and a spoke portion 4 which connects the tread portion 2 and the inner circumferential portion 3. The tread portion 2 includes a first portion 2A having conductivity, and a second portion 2B in contact with the first portion 2A. The second portion 2B, the spoke portion 4, and the inner circumferential portion 3 are formed from a resin or elastomer. The resin or elastomer contains an antistatic agent. The antistatic agent is a polymer-based antistatic agent or surfactant-based antistatic agent. The antistatic agent is blended in an amount of 0.5 to 20% by mass per 100% by mass of a base component of the resin or elastomer.

### BACKGROUND OF THE INVENTION

### Field of the Invention

The present invention relates to an airless tire.

### Background Art

Japanese Laid-Open Patent Publication No. 2021-49977 describes a non-pneumatic tire including a fiber coated with a metal salt, the non-pneumatic tire including a rim portion which is connected to an axle, a tread portion which comes into contact with the ground, and a spoke portion which is formed between the rim portion and the tread portion.

In recent years, it is desired for non-pneumatic tires to maintain high-speed durability while having a function of eliminating static electricity of a vehicle.

The present invention has been made in view of the above circumstances, and a main object of the present invention is to provide an airless tire that can maintain high-speed durability while having a function of eliminating static electricity of a vehicle.

### SUMMARY OF THE INVENTION

The present invention is directed to an airless tire including: an annular tread portion which comes into contact with a road surface; an annular inner circumferential portion which is disposed inward of the tread portion in a tire radial direction and comes into contact with a wheel having conductivity; and a spoke portion which connects the tread portion and the inner circumferential portion, wherein the tread portion includes a first portion having a ground-contact surface and having conductivity, and a second portion placed on the inner circumferential portion side so as to be in contact with the first portion, the second portion, the spoke portion, and the inner circumferential portion are formed from a resin or elastomer, the resin or elastomer contains an antistatic agent, the antistatic agent is a polymer-based antistatic agent or surfactant-based antistatic agent, and the antistatic agent is blended in an amount of 0.5 to 20% by mass per 100% by mass of a base component of the resin or elastomer.

As a result of employing the above configuration, the airless tire of the present invention can maintain high-speed durability while having a function of eliminating static electricity of a vehicle.

### BRIEF DESCRIPTION OF THE DRAWINGS

FIG. 1 is a side view of an airless tire of an embodiment;

FIG. 2 is a perspective view of the airless tire in FIG. 1;

FIG. 3 is an enlarged cross-sectional view of a main part in FIG. 1; and

FIG. 4 is a schematic cross-sectional view conceptually showing an electrical resistance measurement device for airless tires.

### DETAILED DESCRIPTION

Hereinafter, one embodiment of the present invention will be described with reference to the drawings.

It should be understood that the drawings contain exaggerated expressions and expressions that differ from the dimensional ratio of the actual structure in order to help the understanding of the present invention. In addition, when there are a plurality of embodiments, the same or common elements are denoted by the same reference characters throughout the description, and the redundant description thereof is omitted.

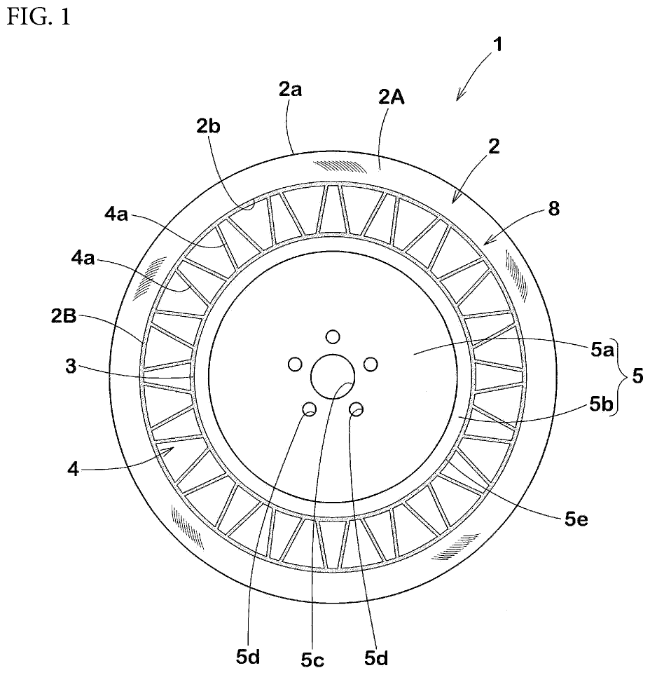

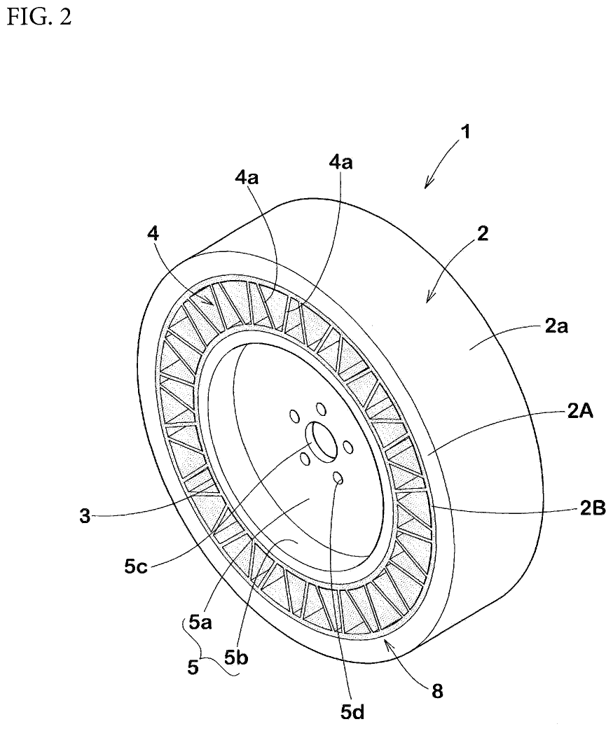

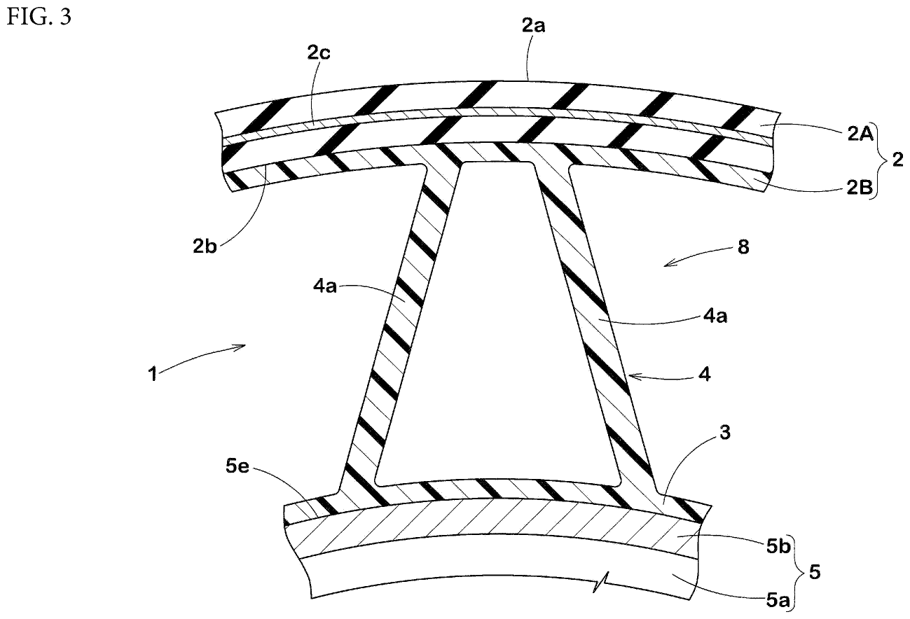

FIG. 1 is a side view of an airless tire (hereinafter, sometimes referred to simply as “tire”) 1 of the present embodiment. FIG. 1 is a perspective view of the tire 1, and FIG. 3 is an enlarged cross-sectional view of a main part in FIG. 1. As shown in FIG. 1 to FIG. 3, the tire 1 includes an annular tread portion 2 which comes into contact with a road surface, an annular inner circumferential portion 3 which is placed inward of the tread portion 2 in the tire radial direction, and a spoke portion 4 which connects the tread portion 2 and the inner circumferential portion 3. The inner circumferential portion 3 is in contact with a wheel 5 having conductivity.

The tread portion 2 includes a first portion 2A having a ground-contact surface 2a and having conductivity, and a second portion 2B placed on the inner circumferential portion 3 side so as to be in contact with the first portion 2A. The ground-contact surface 2a is a surface that comes into contact with a road surface (ground) during running of a vehicle.

The second portion 2B, the spoke portion 4, and the inner circumferential portion 3 are formed from a resin or elastomer (hereinafter, sometimes referred to simply as “resin or the like”) 8, and the resin or the like 8 contains an antistatic agent. The antistatic agent is a polymer-based antistatic agent or surfactant-based antistatic agent. The antistatic agent is blended in an amount of 0.5% by mass or more per 100% by mass of a base component of the resin or the like 8. Such a tire 1 can release static electricity of the vehicle from an axle of the vehicle through the wheel 5, the inner circumferential portion 3, the spoke portion 4, the second portion 2B, and the first portion 2A to a road surface. In order to enhance the function of eliminating static electricity, the antistatic agent is blended in an amount of preferably 2% by mass or more and more preferably 5% by mass or more per 100% by mass of the base component of the resin or the like 8.

The antistatic agent is blended in an amount of 20% by mass or less per 100% by mass of the base component of the resin or the like 8. Accordingly, a decrease in the physical properties of the base component of the resin or the like 8 due to the blending of the antistatic agent is suppressed, and high-speed durability can be maintained high. In order to maintain high-speed durability to be high, the antistatic agent is preferably blended in an amount of 15% by mass or less and more preferably 8% by mass or less per 100% by mass of the base component of the resin or the like 8. In the case where the antistatic agent is a polymer-based antistatic agent, bleed-out of the antistatic agent onto the surfaces of members is suppressed, and the antistatic effect is continued over a long period of time. In addition, the adhesiveness between each member is enhanced by suppressing bleed-out onto the surfaces of the members. Furthermore, with a white or colorless transparent polymer-based antistatic agent, the spoke portion 4 and the inner circumferential portion 3 can be made to have a desired color other than black by adding a pigment or the like.

In the present embodiment, the first portion 2A is an annular rubber member. The first portion 2A is formed from a vulcanized rubber, for example. The ground-contact surface 2a is formed on the outer circumferential surface in the tire radial direction of the first portion 2A. Various drainage grooves (not shown) may be formed on the ground-contact surface 2a.

In a preferable mode, a reinforcing cord layer 2c (shown in FIG. 3) is placed inside the first portion 2A. The reinforcing cord layer 2c is composed of, for example, a layer in which a plurality of organic fiber cords or steel cords are orientated in a predetermined direction. Such a reinforcing cord layer 2c serves to increase the stiffness in the tire circumferential direction and/or the tire axial direction of the first portion 2A and improve steering stability. In addition, a resin material may be added or composited to a part of the first portion 2A.

The second portion 2B is formed, for example, in an annular shape. In the present embodiment, the second portion 2B is joined to an inner circumferential surface 2b in the tire radial direction of the first portion 2A.

The wheel 5 is fixed to the axle (not shown) of the vehicle. The wheel 5 of the present embodiment is made of a metal. As the metal, an iron-based metal, a magnesium-based metal, and a titanium-based metal are preferable, and an aluminum-based metal is particularly preferable. The wheel 5 integrally includes, for example, a disc portion 5a and a cylindrical portion 5b formed outward of the disc portion 5a in the tire radial direction. The disc portion 5a is placed concentrically with the tread portion 2. For example, a center bore 5c, mounting holes 5d, etc., are formed in the disc portion 5a. Static electricity of the vehicle can flow to the axle of the vehicle.

The spoke portion 4 includes, for example, a plurality of elements 4a arranged in the tire circumferential direction. Each element 4a extends in the tire radial direction, and connects the second portion 2B and the inner circumferential portion 3 to each other. Each element 4a can, for example, alleviate the impact inputted to the tread portion 2, by bending during running. The shape, etc., of each element 4a are not limited to those shown, and various modes, such as an element extending in a zigzag manner in the tire radial direction or circumferential direction and an element extending in a mesh-like pattern in a cross-section in the tire circumferential direction, are adopted.

The inner circumferential portion 3 is, for example, joined to an outer circumferential surface (more specifically, the outer circumferential surface of the cylindrical portion 5b) 5e of the wheel 5 (shown in FIG. 3). The inner circumferential portion 3 is adjacent to the cylindrical portion 5b of the wheel 5 on the outer side in the tire radial direction.

As the surfactant-based antistatic agent, for example, nonionic, anionic, and cationic surfactants, polyethylene glycol compounds, etc., are suitable. As the surfactant-based antistatic agent, specifically, trade name “CHEMISTAT (registered trademark)”, trade name “SANSTAT (registered trademark)”, trade name “PEG”, manufactured by Sanyo Chemical Industries, Ltd., etc., are suitable.

The polymer-based antistatic agent preferably contains a thermoplastic resin-based antistatic agent. Even if such a polymer-based antistatic agent bleeds out onto the surface, the polymer-based antistatic agent becomes entangled with the resin or the like 8, and thus is inhibited from being removed by wiping of the surface, etc. Therefore, the polymer-based antistatic agent containing a thermoplastic resin-based antistatic agent can continue its antistatic function for a long period of time. In addition, it is also inferred that, as with the resin or the like 8, such a polymer-based antistatic agent can be recycled by disassembling and pelletizing. As the polymer-based antistatic agent, for example, polymers composed of polyethylene oxide (PEO) chains, polyether-based polymers, etc., are suitable. As the polymer-based antistatic agent, specifically, trade name “PELESTAT (registered trademark)” and trade name “PELECTRON (registered trademark)” manufactured by Sanyo Chemical Industries, Ltd., etc., are suitable.

The resin or the like 8 for the spoke portion 4, the second portion 2B, and the inner circumferential portion 3 preferably has, for example, strength capable of sufficiently exerting load bearing capacity. Accordingly, the impact inputted to the tread portion 2 is alleviated. The resin or the like 8 of the present embodiment is composed of a thermoplastic resin or thermoplastic elastomer. As the thermoplastic resin and the thermoplastic elastomer, for example, polyamide or polyurethane-based resin and elastomer are preferably used, and polyester-based resin and elastomer are particularly preferable. The resin and the elastomer are composed of polymer compounds, and the elastomer is a generic term for elastic polymers.

A complex elastic modulus E* at 30° C. of the resin or the like 8 is preferably not less than 30 MPa and further preferably not less than 50 MPa, and is preferably not greater than 350 MPa and further preferably not greater than 300 MPa. Since the complex elastic modulus E* is not less than 30 MPa, the stiffness of the tire 1 is ensured, and the high-speed durability of the tire 1 is maintained. Since the complex elastic modulus E* is not greater than 350 MPa, the impact inputted to the tread portion 2 can be alleviated. In the present specification, the complex elastic modulus E* is a value measured using a viscoelasticity spectrometer under the following conditions in accordance with JISK6394 “Rubber, vulcanized or thermoplastic—Determination of dynamic properties—General guidance”.
Initial strain: 5%
Amplitude: ±1
Frequency: 10 Hz
Deformation mode: tensile
Viscoelasticity spectrometer: “EPLEXOR (registered trademark)” manufactured by NETZSCH-Geratebau GmbH

The volume resistivity of the resin or the like 8 is preferably not greater than 1.0×10¹⁰ Ω·cm and further preferably not greater than 1.0×10⁶ Ω·cm. Since the volume resistivity of the resin or the like 8 is not greater than 1.0×10¹⁰ Ω·cm, a sufficient antistatic function is exhibited, the bleed-out of the antistatic agent is suppressed, and the change in physical properties is maintained small. The volume resistivity is measured under the condition of a temperature of 23° C. in accordance with the Guarded-electrode system specified in JIS K6271. The volume resistivity is represented by a volume resistivity measured using a sheet (thickness=2 mm) obtained from the resin or the like 8 for forming the spoke portion 4.

Next, a method for producing such a tire 1 will be described. In the method for producing the tire 1 of the present embodiment, the first portion 2A, the second portion 2B, the spoke portion 4, the inner circumferential portion 3, and the wheel 5 are each prepared by a known method. Then, these members are placed in an integral molding mold having a known structure (not shown), and are each adhered with an adhesive, thereby obtaining the tire 1 that is integrally molded. The adhesive and the method for using the adhesive are known adhesives and methods. As the adhesive, for example, trade name “CHEMLOCK” manufactured by Lord Corporation is suitably used. In the case of a polymer-based antistatic agent, bleed-out is suppressed, so that the adhesiveness of such an adhesive is maintained high.

As the method for producing the tire 1, the following embodiment may be employed. In the method for producing the tire 1, the first portion 2A, the spoke portion 4, and the wheel 5 are each prepared by a known method. Then, an adhesive is applied to a surface of each member to be adhered, and these members are placed in an integral molding mold having a known structure (not shown). Next, the resin or the like 8 for forming the inner circumferential portion 3 and the second portion 2B is injected from an injection molding machine having a known structure into the integral molding mold. Accordingly, the tire 1 that is integrally molded is obtained.

In such a production method, the tensile shear strength between the tread portion 2 and the spoke portion 4 and the tensile shear strength between the spoke portion 4 and the inner circumferential portion 3 are each preferably not less than 1.0 MPa in an atmosphere of 20 to 25° C. By specifying such tensile shear strength, high-speed durability is maintained high. The tensile shear strength is measured using a tensile testing machine (trade name: AUTO COM universal testing machine AC-10 kN-C, manufactured by T.S.E. Co., Ltd.) in accordance with the tensile lap-shear strength of adhesives in JIS K6850: 1999. The measurement conditions are as follows
Distance between chucks: 111.5 mm
Test speed: 50 mm/min

The tensile shear strength between the wheel 5 and the inner circumferential portion 3 is preferably not less than 1.0 MPa in an atmosphere of 20 to 25° C. Accordingly, the above-described effects are effectively exhibited.

Although the particularly preferred embodiment of the present invention has been described in detail above, the present invention is not limited to the above-described embodiment, and various modifications can be made to practice the present invention.

### Examples

Airless tires having the basic structure shown in FIG. 1 were produced as test tires on the basis of specifications in Table 1, and were each tested for conductivity and high-speed durability. The common specifications are as follows.
Test tire: equivalent to 145/70R12
Material of first portion: natural rubber+styrene butadiene rubber+steel cord
Material of second portion, spoke portion, and inner circumferential portion: polyester-based thermoplastic resin
Material of wheel: aluminum alloy
Ketjen black: trade name “Ketjen Black” manufactured by Lion Corporation

<Conductivity>

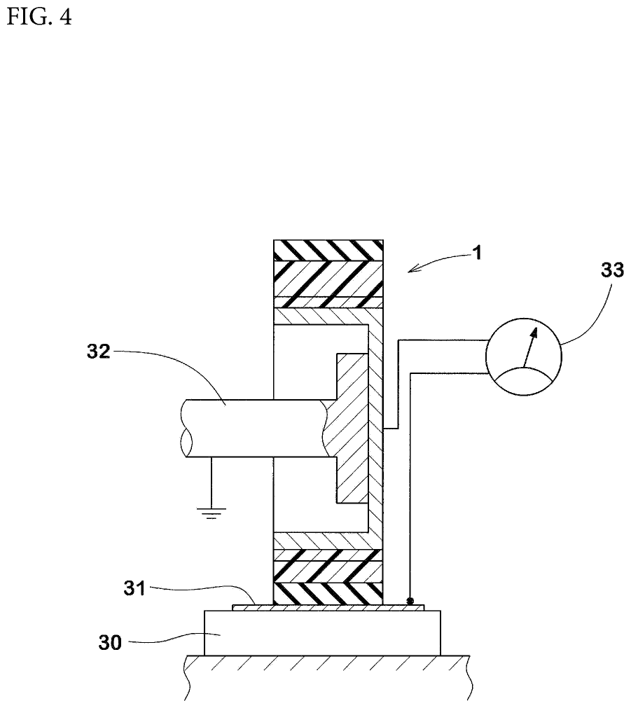

The electrical resistance value of an assembly of the tire 1 was measured in accordance with the JATMA standards using a measurement device as shown in FIG. 4. The measurement device includes a metal plate 31 (having an electrical resistance value of 10Ω or lower) installed on an insulating plate 30 (having an electrical resistance value of 10¹²Ω or higher) and having a polished surface, a conductive tire mounting shaft 32 for holding the tire 1, and an electrical resistance measuring instrument 33. As each test tire 1, a tire from which a mold release agent and stains on the surface thereof had been sufficiently removed in advance and which had been sufficiently dried, was used. Then, the electrical resistance value between the tire mounting shaft 32 and the metal plate 31 was measured by the electrical resistance measuring instrument 33. The other conditions were as follows. As for the results, a tire 1 having an electrical resistance value less than 100 MΩ is acceptable.
Load: 1 kN
Test environment (indoor) temperature and humidity: 25° C./50%
Test voltage (applied voltage): 1000 V

<Durability>

Using a known drum tester, each test tire was caused to run under the following conditions. For the results, a speed obtained by subtracting 10 km/h from the speed at which damage occurred is adopted, and the results are indicated as indexes with the speed of Comparative Example 1 being regarded as 100. The higher the value is, the better the result is.
Speed: The initial speed was 100 km/h and was increased by 10 km/h every 10 minutes.
Load: 1 kN

The results are shown in Table 1. The “blending amount” described in Table 1 is the ratio of the antistatic agent to 100% by mass of the base component of the resin or the elastomer (% by mass).

TABLE 1

| | Comparative | Comparative | Example | Example |
|---|---|---|---|---|
| | Example 1 | Example 2 | 1 | 2 |
| Blending amount of | — | 30 | — | — |
| ketjen black | | | | |
| Blending amount of | — | — | 1 | 20 |
| PELECTRON | | | | |
| Blending amount | — | — | — | — |
| of surfactant | | | | |
| Conductivity | | | | |
| [MΩ: less than 100 | 400 | 2 | 80 | 10 |
| is acceptable] | | | | |
| High-speed durability | | | | |
| [Score: higher value | 100 | 83 | 100 | 100 |
| is better] | | | | |

As a result of the tests, it is understood that the tire of each Example maintains high-speed durability while having a function of eliminating static electricity of a vehicle, as compared to that of each Comparative Example.

[Additional Notes]

The present invention includes the following aspects.

[Present Invention 1]

An airless tire including: an annular tread portion which comes into contact with a road surface; an annular inner circumferential portion which is disposed inward of the tread portion in a tire radial direction and comes into contact with a wheel having conductivity; and a spoke portion which connects the tread portion and the inner circumferential portion, wherein
the tread portion includes a first portion having a ground-contact surface and having conductivity, and a second portion placed on the inner circumferential portion side so as to be in contact with the first portion,
the second portion, the spoke portion, and the inner circumferential portion are formed from a resin or elastomer,
the resin or elastomer contains an antistatic agent,
the antistatic agent is a polymer-based antistatic agent or surfactant-based antistatic agent, and
the antistatic agent is blended in an amount of 0.5 to 20% by mass per 100% by mass of a base component of the resin or elastomer.

[Present Invention 2]

The airless tire according to Present Invention 1, wherein the polymer-based antistatic agent contains a thermoplastic resin-based antistatic agent.

[Present Invention 3]

The airless tire according to Present Invention 1 or 2, wherein the resin or elastomer is a thermoplastic resin or thermoplastic elastomer.

[Present Invention 4]

The airless tire according to Present Invention 1 or 2, wherein the resin or elastomer has a complex elastic modulus E* at 30° C. of 30 to 350 MPa.

[Present Invention 5]

The airless tire according to Present Invention 1 or 2, wherein the resin or elastomer has a volume resistivity of 1.0×10⁶ to 1.0×10¹⁰ Ω·cm.

[Present Invention 6]

The airless tire according to Present Invention 1 or 2, wherein a tensile shear strength between the tread portion and the spoke portion and a tensile shear strength between the spoke portion and the inner circumferential portion are each not less than 1.0 MPa in an atmosphere of 20 to 25° C.

[Present Invention 7]

The airless tire according to Present Invention 1 or 2, wherein a tensile shear strength between the wheel and the inner circumferential portion is not less than 1.0 MPa in an atmosphere of 20 to 25° C.

What is claimed is:

1. An airless tire comprising:
an annular tread portion configured to contact a road surface;
an annular inner circumferential portion inward of the tread portion in a tire radial direction and configured to contact a wheel having conductivity; and
a spoke portion which connects the tread portion and the inner circumferential portion, wherein
the tread portion includes a first portion having a ground-contact surface and having conductivity, and a second portion on the inner circumferential portion side in contact with the first portion,
the second portion, the spoke portion, and the inner circumferential portion include a resin or elastomer,
the resin or elastomer includes an antistatic agent,
the antistatic agent is a polymer-based antistatic agent or surfactant-based antistatic agent, and
the antistatic agent is blended in an amount of 0.5 to 20% by mass per 100% by mass of a base component of the resin or elastomer.

2. The airless tire according to claim 1, wherein
the polymer-based antistatic agent includes a thermoplastic resin-based antistatic agent.

3. The airless tire according to claim 1, wherein
the resin or elastomer is a thermoplastic resin or thermoplastic elastomer.

4. The airless tire according to claim 1, wherein
the resin or elastomer has a complex elastic modulus E* at 30° C. of 30 to 350 MPa.

5. The airless tire according to claim 1, wherein
the resin or elastomer has a volume resistivity of 1.0×10⁶ to 1.0×10¹⁰ Ω·cm.

6. The airless tire according to claim 1, wherein
a tensile shear strength between the tread portion and the spoke portion and a tensile shear strength between the spoke portion and the inner circumferential portion are each not less than 1.0 MPa in an atmosphere of 20 to 25° C.

7. The airless tire according to claim 1, wherein
a tensile shear strength between the wheel and the inner circumferential portion is not less than 1.0 MPa in an atmosphere of 20 to 25° C.
